(19) United States
(12) Patent Application Publication
(10) Pub. No.: US 2021/0027313 A1
(43) Pub. Date: Jan. 28, 2021

(54) Data Representations for a Sales Facilitation Operation

(71) Applicant: Dell Products L.P., Round Rock, TX (US)

(72) Inventors: Bud Koch, Austin, TX (US); Indravijay J. Gohil, Austin, TX (US); Sabita Bikki, Tomball, TX (US); Tobin C. Rysenga, Austin, TX (US)

(73) Assignee: Dell Products L.P., Round Rock, TX (US)

(21) Appl. No.: 16/522,158

(22) Filed: Jul. 25, 2019

(51) Int. Cl. G06Q 30/02

(52) U.S. Cl. CPC G06Q 30/0201

(57) ABSTRACT

A system, method, and computer-readable medium are disclosed for facilitating a sale of an asset used in a complex asset environment via a sales facilitation operation. In various embodiments the sales facilitation operation includes: identifying a plurality of assets within a complex asset environment; collecting information regarding the plurality of assets within the complex asset environment, the information regarding each of the plurality of assets comprising information from a plurality of data sources; ingesting the information regarding the plurality of assets within the complex asset environment into a sales facilitation system; and, performing the sales facilitation operation using the information regarding each of the plurality of assets within the complex asset environment.

### BACKGROUND OF THE INVENTION

### Field of the Invention

The present invention relates to information handling systems. More specifically, embodiments of the invention relate to facilitating a sale of an asset used in a complex asset environment.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

A system, method, and computer-readable medium are disclosed for facilitating a sale of an asset used in a complex asset environment.

More specifically, in one embodiment the invention relates to a computer-implementable method for performing a sales facilitation operation, comprising: identifying a plurality of assets within a complex asset environment; collecting information regarding the plurality of assets within the complex asset environment, the information regarding each of the plurality of assets comprising information from a plurality of data sources; ingesting the information regarding the plurality of assets within the complex asset environment into a sales facilitation system; and, performing the sales facilitation operation using the information regarding each of the plurality of assets within the complex asset environment.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: identifying a plurality of assets within a complex asset environment; collecting information regarding the plurality of assets within the complex asset environment, the information regarding each of the plurality of assets comprising information from a plurality of data sources; ingesting the information regarding the plurality of assets within the complex asset environment into a sales facilitation system; and, performing the sales facilitation operation using the information regarding each of the plurality of assets within the complex asset environment.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a sales facilitation environment.

FIG. 3 shows a functional block diagram of a sales facilitation system architecture.

FIG. 4 shows the orchestration of elements of a sales facilitation environment.

FIG. 5 shows a simplified process flow of the operation of a sales facilitation environment.

FIG. 6 shows a simplified process flow for generating a candidate complex asset environment.

FIG. 7 shows a simplified process flow for generating a sales opportunity insight.

### DETAILED DESCRIPTION

A system, method, and computer-readable medium are disclosed for facilitating a sale of an asset used in a complex asset environment. Certain aspects of the invention reflect an appreciation that the multifaceted nature of complex asset environments, described in greater detail herein, often present challenges to sales personnel when attempting to make a sale. Certain aspects of the invention likewise reflect an appreciation that sales opportunities in a complex asset environment are not always obvious. Likewise, various aspects of the invention reflect an appreciation that the performance of certain sales facilitation operations, as described in greater detail herein, may assist sales personnel in identifying, and closing, a sale of an asset used in a complex asset environment.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

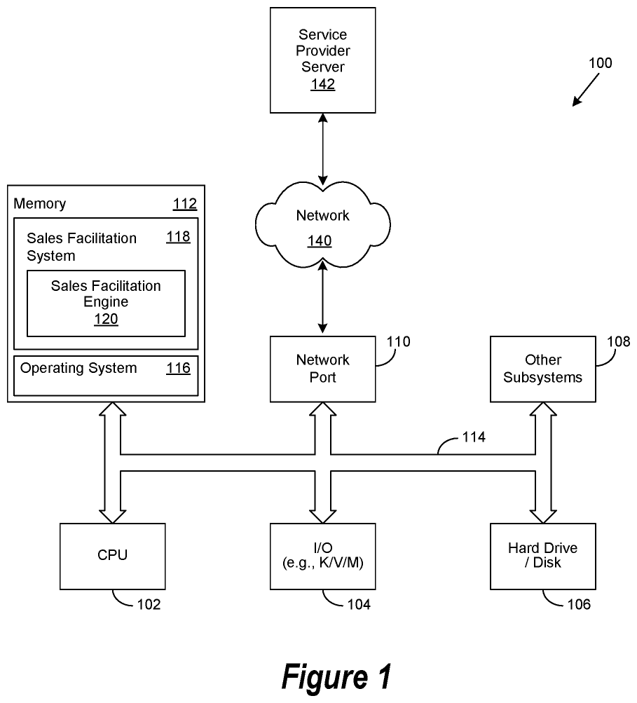

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also include a sales facilitation system 118. Ian certain embodiments, the sales facilitation system 118 may be implemented to include a sales facilitation engine 120. In one embodiment, the information handling system 100 is able to download the sales facilitation system 118 from the service provider server 142. In another embodiment, the sales facilitation system 118 is provided as a service from the service provider server 142.

The sales facilitation system 118 performs a sales facilitation operation. The sales facilitation operation improves processor efficiency, and thus the efficiency of the information handling system 100, by facilitating the sales facilitation operation. In certain embodiments, the sales facilitation operation can be performed during operation of an information handling system 100. As will be appreciated, once the information handling system 100 is configured to perform the sales facilitation operation, the information handling system 100 becomes a specialized computing device specifically configured to perform the sales facilitation operation and is not a general purpose computing device. Moreover, the implementation of the sales facilitation operation on the information handling system 100 improves the functionality of the information handling system 100 and provides a useful and concrete result of more optimizing the performance of a sales operation or process in a complex asset environment than would be realized without the sales facilitation operation.

In certain embodiments, the sales facilitation system 118 is implemented to execute the sales facilitation operation within an enterprise Information Technology (IT) infrastructure. For the purposes of the present disclosure, an enterprise IT infrastructure may be defined as an IT information handling system environment for a particular organizational unit that is used to provide a certain IT functionality for the organizational unit. It will be appreciated that the IT information handling system environment may include one or more information handling systems 100 such as server-type information handling system 100.

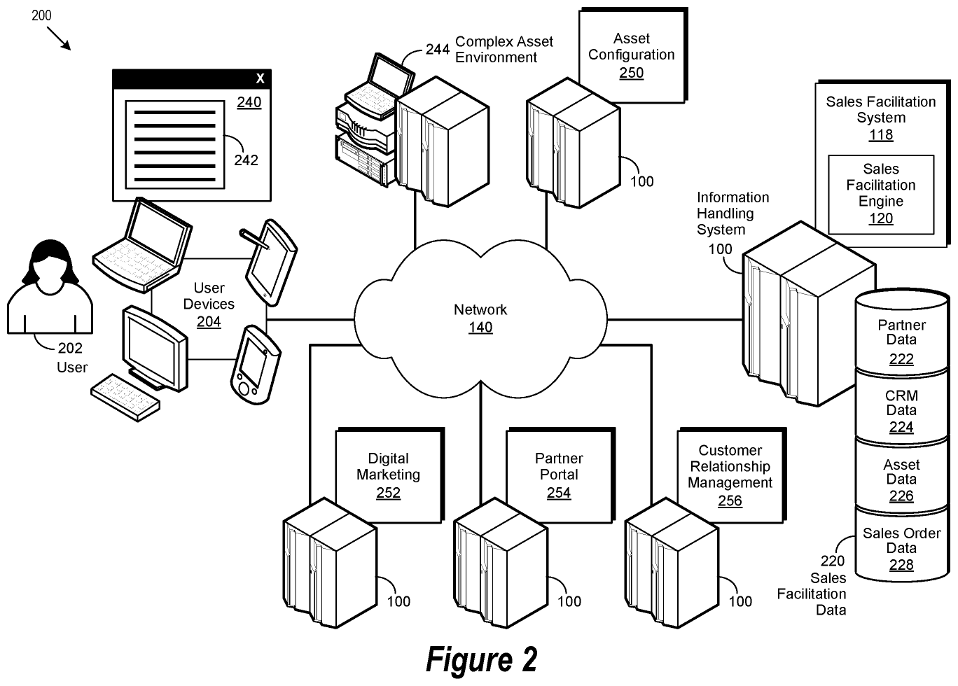

FIG. 2 is a block diagram of a sales facilitation environment implemented in accordance with an embodiment of the invention. In certain embodiments, the sales facilitation environment 200 may include a sales facilitation system 118. In certain embodiments, the sales facilitation environment 200 may include a repository of sales facilitation data 220. In certain embodiments, the repository of sales facilitation data 220 may be local to the system executing the sales facilitation system 118 or may be executed remotely. In certain embodiments, the repository of sales facilitation data 220 may include various information associated with partner data 222, customer relationship management (CRM) data 224, asset data 226, and sales order data 228.

As used herein, a partner broadly refers to an entity having some form of alliance with another entity. In certain embodiments, the alliance may be between two or more commercial entities. One example of such a commercial alliance is a co-marketing partnership, where the entities agree to work together in a mutually beneficial manner to jointly market each other's products or services. To continue the example, a computer manufacturer may have a contractual relationship with a provider of Enterprise Resource Planning (ERP) software to co-market a turn-key solution to certain market segments.

Another example of a commercial alliance is a channel partner. As used herein, a channel partner broadly refers to an entity that contractually agrees to market and sell certain assets another entity manufactures or provides. Yet another example of a commercial alliance is a referral partner. As used herein, a referral partner broadly refers to any entity, such as a manufacturer's representative, who refers new customers to another entity in any number of ways. Skilled practitioners of the art will recognize that many such examples of commercial alliances are possible. Accordingly, the foregoing is not intended to limit the spirit, scope, or intent of the invention.

As used herein, customer relationship management (CRM) data 226 broadly refers to any information associated with an interaction with a prospective or existing customer. In certain embodiments, the performance of one or more sales facilitation operations, described in greater detail herein, may be stored in the repository of CRM data 226. In various embodiments, certain CRM data 226 may likewise be used in the performance of a sales facilitation operation.

As used herein, asset data 226 broadly refers to any information associated with an asset. In certain embodiments, the asset data 226 may include information associated with asset types, asset quantities, asset use types, optimization types, asset workloads, asset performance, support information, and cost factors, or a combination thereof, as described in greater detail herein. In certain embodiments, the asset data 226 may include information associated with asset utilization patterns, likewise described in greater detail herein.

As used herein, an asset broadly refers to anything tangible or intangible that can be owned or controlled to produce value. In certain embodiments, an asset may include a product, a service, or a combination thereof. As used herein, a tangible asset broadly refers to asset having a physical substance, such as currencies or other financial assets, buildings, real-estate, inventories, and commodities of any kind. Other examples of tangible assets may include various types of equipment, such as computing and network devices. Examples of computing devices may include personal computers (PCs), laptop PCs, tablet computers, servers, mainframe computers, Random Arrays of Independent Disks (RAID) storage units, their associated internal and external components, and so forth. Likewise, examples of network devices may include routers, switches, hubs, repeaters, bridges, gateways, and so forth. Further examples of tangible assets may include vehicles, such as bicycles, motorcycles, passenger cars, trucks of any size, configuration or capacity, trains, airplanes of various types, and so forth.

As likewise used herein, an intangible asset broadly refers to an asset that lacks physical substance. Examples of intangible assets may include software, firmware, and other non-physical, computer-based assets. Other examples of intangible assets may include digital assets, such as structured and unstructured data of all kinds, still images, video images, audio recordings of speech, music, and other sounds, and so forth. Further examples of intangible assets may include intellectual property, such as patents, trademarks, copyrights, trade names, franchises, goodwill, and knowledge resources. Those of skill in the art will recognize that many such examples of tangible and intangible assets are possible. Accordingly, the foregoing is not intended to limit the spirit, scope or intent of the invention.

In certain embodiments, the value produced by an asset may be tangible or intangible. As used herein, tangible value broadly refers to value that can be measured. Examples of tangible value may include return on investment (ROI), total cost of ownership (TCO), internal rate of return (IRR), increased performance, more efficient use of resources, improvement in sales, decreased customer support costs, and so forth. As likewise used herein, intangible value broadly refers to value that provides a benefit that may be difficult to measure. Examples of intangible value may include improvements in user experience, customer support, and market perception. Skilled practitioner of the art will recognize that many such examples of tangible and intangible value are possible. Accordingly, the foregoing is not intended to limit the spirit, scope or intent of the invention.

As used herein, a sales order broadly refers to a collection of data documenting an entity's intent to fulfill an order placed by an ordering entity for a particular asset. In certain embodiments, the sales order may be implemented in part or in whole, in physical form, digital form, or a combination thereof. In certain embodiments, an order for an asset may be in the form of a purchase order. As used herein, a purchase order broadly refers to a commercial document indicating types, quantities, and agreed-upon prices for provision of a particular asset. In certain embodiments, the entity issuing a purchase order may be an individual, a group, or other organization, such as a company or government agency.

In certain embodiments, a sales order may be implemented to include a record of a purchase order issued by an ordering entity. In certain embodiments, the receipt of an ordering entity's purchase order may trigger the creation of a sales order. In certain embodiments, a sales order may be implemented to contain, or reference, one or more purchase orders associated with an ordering entity.

In certain embodiments, a sales order may be implemented in a manufacturing environment to generate one or more work orders. As used herein, a work order broadly refers to a collection of data containing information associated with manufacturing, building, engineering, configuring, or otherwise providing a particular asset. In certain embodiments, the information contained in a work order may include instructions of various kinds, cost estimates, forms, dates and times to execute the work order, information related to the locations and entities involved in executing the work order, individual entities associated with the work order, or a combination thereof.

In certain embodiments, the fulfillment of a sales order for a product may include provision of an original digital good, or a copy thereof, a build-to-stock product, a built-to-order product, a configured-to-order product, or an engineered-to-order product. In various embodiments, the fulfillment of an order for a service may include performance of certain operations, processes, or a combination thereof. In certain embodiments, the sales order may be for one or more assets used in a complex asset environment 244.

As used herein, a complex asset environment 244 broadly refers to a collection of interrelated assets implemented to work in combination with one another for a particular purpose. In certain embodiments, various assets within a complex asset environment may have certain interdependencies. As an example, a data center may have multiple servers interconnected by a storage area network (SAN) providing block-level access to various disk arrays and tape libraries. In this example, the servers, various physical and operational elements of the SAN, as well the disk arrays and tape libraries, are interdependent upon one another.

In certain embodiments, each asset in a complex asset environment 244 may be treated as a separate asset and depreciated individually according to their respective attributes. As an example, a fleet of maintenance vehicles may be made up of a variety of passenger automobiles, delivery vans, light, medium, and heavy duty trucks, fork lifts, and mobile cranes, each of which may have a different depreciation schedule. To continue the example, certain of these assets may be implemented in different combinations to produce an end result. To further illustrate the example, a heavy duty truck may be used to deliver roofing materials, which are then lifted to the rooftop of a commercial structure by a mobile crane, and once in place, installed by a work crew that may have traveled to the job site in various light trucks and vans. As another example, the same heavy duty truck may be used the next day to deliver paver bricks, which are then unloaded with a forklift, and once unloaded, installed by a different work crew that may have used a variety of light trucks to travel to the jobsite.

In certain embodiments, each asset in a complex asset environment 244 may have an associated maintenance schedule and service contract. For example, a complex asset environment such as a data center may include a wide variety of servers and storage arrays, which may respectively be manufactured by a variety of manufacturers. In this example, the frequency and nature of scheduled maintenance, as well as service contract terms and conditions, may be different for each server and storage array. In certain embodiments, the individual assets in a complex asset environment 244 may be configured differently, according to their intended use. To continue the previous example, various servers may be configured with faster or additional processors for one use, while other servers may be configured with additional memory for other uses. Likewise, certain storage arrays may be configured as one RAID configuration, while others may be configured as a different RAID configuration.

In certain embodiments, the sales facilitation system 118 may include a sales facilitation engine 120. In certain embodiments, the sales facilitation system 118 may be implemented to perform various sales facilitation operations. In certain embodiments, the sales facilitation operation may be executed to facilitate the conversion of a sales opportunity into a sales order, as described in greater detail herein. As used herein, a sales opportunity broadly refers to an opportunity to sell, or otherwise provide, one or more assets, described in greater detail herein, to a qualified sales contact. As used herein, a qualified sales contact broadly refers to an entity, likewise described in greater detail herein, who meets certain qualification criteria.

Examples of qualification criteria may include whether the entity has certain needs driving the purchase of a particular asset and whether or not the purchase needs to be made by a certain date. Other examples of qualification criteria may include whether budget has been allocated for purchasing a particular asset and whether there is an identified decision maker. Those of skill in the art will recognize that many examples of such qualification criteria are possible. Accordingly, the foregoing is not intended to limit the spirit, scope or intent of the invention. In certain embodiments, the sales facilitation engine 120 may be implemented, as described in greater detail herein, to analyze data associated with a target complex asset environment 244, perform various corresponding ROI, TCO, and IRR calculations, and propose associated sales facilitation recommendations.

In certain embodiments, a user 202 may use a user device 204 to interact with the sales facilitation system 118. As used herein, a user device 204 refers to an information handling system such as a personal computer, a laptop computer, a tablet computer, a personal digital assistant (PDA), a smart phone, a mobile telephone, or other device that is capable of communicating and processing data. In certain embodiments, the user device 204 may be configured to present a sales facilitation system user interface (UI) 240. In certain embodiments, the sales facilitation system UI 240 may be implemented to present a graphical representation 242 of sales facilitation information, which is automatically generated in response to interaction with the sales facilitation system 118.

In certain embodiments, the user device 204 may be used to exchange information between the user 202 and the sales facilitation system 118, an asset configuration system 250, a digital marketing system 252, a partner portal 254, and a CRM system 256, or a combination thereof, through the use of a network 140. In certain embodiments, the asset configuration system 250 may be implemented to configure various assets to meet various financial, profit margin, performance, and performance equivalence goals, as described in greater detail herein. In various embodiments, the asset configuration system 250 may be implemented to use certain sales facilitation data 220 to perform such configuration.

In certain embodiments, the digital marketing system 252 may be implemented to market various assets to prospective or existing customers. In various embodiments, the digital marketing system 252 may be implemented to perform certain digital marketing methods. Examples of such methods include as search engine optimization (SEO), content marketing, influencer marketing, content automation, and campaign marketing. Other examples of such methods include data-driven marketing, electronic commerce marketing, social media marketing, social media optimization, and e-mail direct marketing. In various embodiments, the digital marketing system 252 may be implemented to use certain sales facilitation data 220 in the performance of digital marketing methods used to target individual, or groups of, prospective and existing customers.

In certain embodiments, the partner portal 254 may be implemented to provide a channel of communication for a prospective or existing customer. In various embodiments, partner portal 254 may be implemented to provide certain sales facilitation content, described in greater detail herein, to a prospective or existing customer. In various embodiments, the CRM system 256 may be implemented to manage, and track, the performance of certain sales facilitation operations, likewise described in greater detail herein, provided by the sales facilitation system 118. In various embodiments, the performance of such sales facilitation operations may involve interactions with certain users 202, such as sales personnel. In certain embodiments, the network 140 may be a public network, such as a public internet protocol (IP) network, a physical private network, a wireless network, a virtual private network (VPN), or any combination thereof. Skilled practitioners of the art will recognize that many such embodiments are possible and the foregoing is not intended to limit the spirit, scope or intent of the invention.

In various embodiments, the sales facilitation system UI 240 may be presented via a website. In certain embodiments, the website may be provided by one or more of the sales facilitation system 118, the asset configuration system 250, the digital marketing system 252, the partner portal 254, or the CRM system 256. For the purposes of this disclosure a website may be defined as a collection of related web pages which are identified with a common domain name and is published on at least one web server. A website may be accessible via a public IP network or a private local network.

A web page is a document which is accessible via a browser which displays the web page via a display device of an information handling system. In various embodiments, the web page also includes the file which causes the document to be presented via the browser. In various embodiments, the web page may comprise a static web page, which is delivered exactly as stored and a dynamic web page, which is generated by a web application that is driven by software that enhances the web page via user input to a web server.

In certain embodiments, the sales facilitation system 118 may be implemented to interact with the asset configuration system 250, the digital marketing system 252, the partner portal 254, and the CRM system 256, or a combination thereof, each of which in turn may be executing on a separate information handling system 100. In certain embodiments, the sales facilitation system 118 may be implemented to interact with the asset configuration system 250, the digital marketing system 252, the partner portal 254, and the CRM system 256, or a combination thereof to perform a sales facilitation operation, as described in greater detail herein.

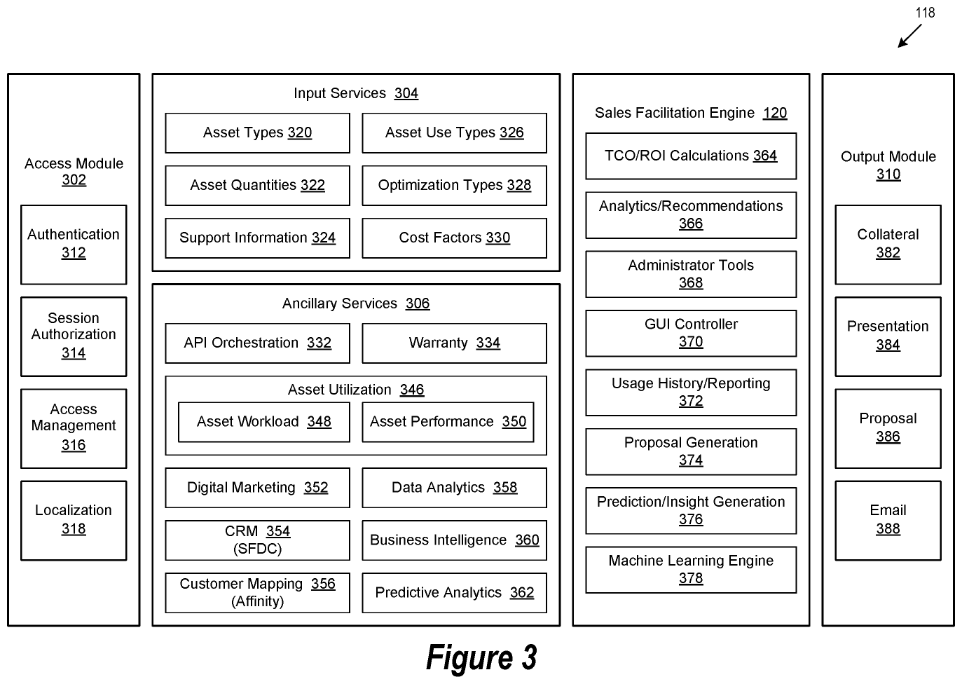

FIG. 3 shows a functional block diagram of a sales facilitation system architecture implemented in accordance with an embodiment of the invention. In certain embodiments, a sales facilitation system 118, described in greater detail herein, may be implemented to include an access module 302, various input 304 and ancillary 306 services, a sales facilitation engine 120, and an output module 310. In certain embodiments, the access module 302 may be implemented to include authentication 312, session authorization 314, identity access management 316, and localization 318 components, or a combination thereof.

In certain embodiments, the authentication 312 component may be implemented to perform authentication operations familiar to skilled practitioners of the art. In certain embodiments, the authentication operations may be performed to authenticate a user of the sales facilitation system 118. In certain embodiments, the authentication operations may be performed to authenticate another system interacting with the sales facilitation system 118. In certain embodiments, the authentication operations may be performed to authenticate a particular function, operation, or process provided by a service, such as a web service implemented in a cloud environment.

In certain embodiments, the session authorization 314 component may be implemented to perform session authorization operation familiar to those of skill in the art. In certain embodiments, the session authorization operations may be performed to authorize a session for a user of the sales facilitation system 118. In certain embodiments, the session authorization operations may be performed to authorize a session for another system interacting with the sales facilitation system 118. In certain embodiments, the session authorization operations may be performed to authorize a particular function, operation, or process provided by a service, such as a web service implemented in a cloud environment, during a session.

In certain embodiments, the identity access management 316 component may be implemented to provide a framework for ensuring appropriate access to sales facilitation system 118 resources. In various embodiments, such sales facilitation resources 118 may include access to the sales facilitation system 118, or certain components and services thereof, information related to a sales opportunity, information related to sales personnel associated with a particular sales opportunity, or a combination thereof. As an example, two channel partners of a manufacturer may have both been granted access to the manufacturer's sales facilitation system. However, the identity access management 316 component may have been implemented that one channel partner cannot generally gain access to information associated with sales opportunities assigned to the other channel partner. Conversely, the identity management 316 may likewise be implemented to allow both channel partners to gain access to information associated with certain sales opportunities where the two channel partners have agreed with the manufacturer to work collaboratively.

In certain embodiments, the localization 318 component may be implemented to adapt various interactions with the sales facilitation system 118 to accommodate language, units of measure, and other locale-specific requirements. As an example, the localization component 318 may be implemented to provide an American user of the sales facilitation system 118 textual and speech information in American English, units of measure in United States customary units, (e.g., inches, ounces, etc.), and pricing in American currency. As another example, the localization component 318 may be implemented to provide a United Kingdom user of the sales facilitation system 118 textual and speech information in British English, units of measure in Imperial units, (e.g., inches, ounces, etc.), and pricing in pounds sterling, or portions thereof. As yet another example, the localization component 318 may be implemented to provide a French user of the sales facilitation system 118 textual and speech information in French, units of measure in metric units, (e.g., centimeter, liter, etc.), and pricing in Euros, or portions thereof. Skilled practitioners of the art will recognize many such examples of the implementation of the localization component 318 are possible. Accordingly, the foregoing is not intended to limit the spirit, scope or intent of the invention/

In certain embodiments, various input services 304 may be implemented, including asset types 320, asset quantities 322, support information 324, asset use types 326, optimization types 328, and cost factors 330, or a combination thereof. In certain embodiments, data associated with the input services 304 may be received from one or more associated systems or data sources, in part or in combination, as needed to perform a sales facilitation operation. In certain embodiments, data respectively associated with various input services 304 used in the performance of a sales facilitation operation may be interrelated, have interdependencies between one another, or a combination thereof.

In certain embodiments, the sales facilitation operation may include processing various input service 304 data to generate an abstract, or detailed, description of a complex asset environment. In certain embodiments, performance of a sales facilitation operation may result in the provision of associated data to one or more systems or data sources, in part or in combination, associated with various input services 304. In these embodiments, the method by which such data is received from, or provided to, a system or data source respectively associated with each of the input services 304 is a matter of design choice.

In certain embodiments, the asset types 320 services may be implemented to provide data associated with the types of assets used in a complex asset environment. In certain embodiments, the asset type data may include asset classes, model names and numbers, configurations, functionalities, operational parameters, and so forth. As used herein, operational parameters broadly refer to any attribute, or identifiable characteristic, of an asset that can be used to describe or evaluate its operational capabilities, performance, status, condition, and so forth. In certain embodiments, the asset quantities 322 services may be implemented to provide data associated with the number of various assets used in a complex asset environment. In certain embodiments, the asset quantity data may be used in combination with certain location data to provide information related to how many of a certain type of asset is used in a particular location, such as a data center.

In certain embodiments, the support information 324 services may be implemented to provide support entitlements for individual assets in a complex asset environment. As an example, a particular asset may have an associated service tag, which not only uniquely references the asset, but also correlates to one or more service entitlements. To continue the example, the organization that owns the asset may have a blanket service agreement from the manufacture of certain classes or types of assets, such as servers and storage arrays, which specifies which service organization the manufacturer has designated to service a malfunctioning asset. To continue the example, servers may have one service entitlement that specifies one service interval, while storage arrays may have a second service entitlement that specifies a different service interval.

To further continue the example, servers may have a unit replacement service entitlement where a blade server may be replaced in whole, whereas storage arrays may have a component replacement service entitlement, where individual disk drives may be replaced as needed. To continue the example even further, certain classes of servers may have a unit replacement service entitlement where a blade server may be replaced within twenty four hours, eight hours, one hour, and so forth. Likewise, storage arrays used for certain purposes may also have a corresponding component replacement service entitlement where individual disk drives may also be replaced within twenty four hours, eight hours, one hour, and so forth, dependent upon the function they perform.

In certain embodiments, the asset use types 326 services may be implemented to provide information associated with how a particular asset may be used in a complex asset environment. To use the prior example, certain servers in a data center may be dedicated to hosting web sites, while others may be assigned to querying datastores, while still others may be implemented to dynamically provide cloud-based web services of various kinds. Likewise, certain storage arrays may be assigned, individually, in part, or in combination, to provide access to data associated with such uses. Accordingly, certain embodiments of the invention reflect an appreciation that the ability to use such information associated with how a particular asset may be utilized, whether individually or in combination with another asset, may prove useful in the performance of various sales facilitation operations.

In certain embodiments, the optimization types 328 service may be implemented to provide information associated with how one or more assets may be optimized in a complex asset environment. In certain embodiments, the optimization may be related to performance, cost, form factor, supported uses, configuration, scalability, power usage, or a combination thereof. As an example, a customer may wish to achieve the optimal performance of all assets within a complex asset environment for one or more uses. Conversely, the customer may wish to achieve the lowest total cost of ownership (TCO) for all assets in a particular complex asset environment. Alternatively, the customer may wish to achieve the highest possible performance at the lowest possible cost, in concert with the greatest return on investment, for certain assets within their overall complex asset environment.

To further continue a prior example, a particular server may be used to perform blockchain operations, which those of skill in the art recognize are computationally intensive. In this example, the server may be implemented with the maximum number of Central Processor Units (CPUs) it can support. However, its performance in performing blockchain operations may not be meeting expectations. Accordingly, implementation of certain optimization types 328 services may result in the recognition that the server's blockchain operation performance could be improved if one or more Graphic Processor Units (GPUs), which the server's configuration is capable of supporting, were to be implemented. In further continuance of the prior example, implementation of certain optimization types 328 services may result in the recognition that the performance of a server used to provide cloud-based web services may be improved if the size of its main memory is increased.

In certain embodiments, the cost factors 330 services may be implemented to provide information associated with the cost of one or more assets in a complex asset environment. In certain embodiments, the cost information may be related to the original cost of an asset, the respective cost of its component parts, its current market value, its depreciated value, or a combination thereof. In certain embodiments, the cost information may be related to the cost of operating, using, maintaining, or storing the asset. In certain embodiments, the cost information may be related to the TCO or ROI of a particular asset. In view of the foregoing, skilled practitioners of the art will recognize that many examples of input services 304 are possible for use in performing a sales facilitation operation. Accordingly, the foregoing is not intended to limit the spirit, scope or intent of the invention.

In certain embodiments, various ancillary services 306 may be implemented, including Application Program Interface (API) orchestration 332, warranty 334, asset utilization 346, digital marketing 256, customer mapping 356, business intelligence (BI) 360, and predictive analytics 362 services, or a combination thereof. In certain embodiments, data associated with the input services 304 may be received from one or more associated systems or data sources, in part or in combination, as needed to perform a sales facilitation operation. In certain embodiments, performance of a sales facilitation operation may result in the provision of associated data to one or more systems or data sources, in part or in combination, associated with various input services 304. In these embodiments, the method by which such data is received from, or provided to, a system or data source respectively associated with each of the input services 304 is a matter of design choice.

In certain embodiments, the API orchestration 332 service may be implemented to coordinate access to various services through API calls, familiar to those of skill in the art, by the sales facilitation system 118. In certain embodiments, the API orchestration 332 service may be implemented to coordinate requests for, and responses from, various services by splitting, merging, routing, or some combination thereof, various API calls. In certain embodiments, the API orchestration 332 service may be implemented to automate the configuration, coordination, and management of various information handling systems and associated services in a cloud environment. In certain embodiments, the API orchestration 332 service may be implemented to provide such services in a cloud environment as virtualized services, familiar to skilled practitioners of the art. Those of skill in the art will recognize that many such embodiments of the implementation of the API orchestration 332 service are possible. Accordingly, the foregoing is not intended to limit the spirit, scope, or intent of the invention.

In certain embodiments, the warranty 334 service may be implemented to provide warranty information associated with a particular asset for use in a complex asset environment. As used herein, a warranty broadly refers to a promise that is not a condition of a contract, such as a contract associated with the purchase of an item or a service. However, a warranty may be a term of a contract, such that a product warranty may be made by a manufacturer to a user of a product the manufacturer has no direct relationship. As an example, a manufacturer may sell their products through a channel partner, who owns the sales relationship with the purchaser of one of the manufacturer's product. In this example, the manufacturer may not have a direct relationship with the purchaser of the product, yet the manufacturer ensures the terms and conditions of the product's associated warranty are honored.

In certain embodiments, the asset utilization services 346 may be implemented to provide information related to the utilization of various assets in a complex asset environment. As used herein, in relation to an asset for use in a complex asset environment, utilization broadly refers to the extent an asset's productive capacity is being used at a particular point in time. In certain embodiments, asset utilization in a complex asset environment may reflect the relationship between the capacity of an asset that is being produced and the potential output of the asset if its capacity was fully used.

In various embodiments, the asset utilization services 346 may be implemented to include certain asset workload 348 and asset performance 350 services. As used herein, in relation to an asset for use in a complex asset environment, asset workload broadly refers to the output of an asset when performing a particular operation, function, or process. In various embodiments, an asset workload 348 service may be implemented to provide information associated with the output of certain assets when tasked with performing a particular workload.

Certain embodiments of the invention reflect an appreciation that various workloads may have certain associated characteristics which may affect the output of a particular asset. Certain embodiments of the invention likewise reflect an appreciation that it is sometimes possible to modify an asset, such as by changing its configuration, to increase its output or otherwise improve its ability to handle a particular workload. Certain embodiments of the invention likewise reflect an appreciation that it may be advantageous to assess the current output of an asset for a particular workload, and its ability to accommodate such modifications or changes in configuration, before they are made.

As an example, a truck may be equipped with springs capable of supporting a particular load capacity and its engine may be capable of sustaining a certain speed when the truck's payload capacity is at its maximum. To continue the example, the truck may be capable of being retrofitted with springs capable of supporting a higher load capacity and a turbocharger to increase its horsepower or torque. In this example, the asset workload 348 service may be implemented to first determine the truck's current load capacity and the speed it is capable of maintaining without a turbocharger. In this example, the asset workload 348 service may likewise be implemented to determine the truck's payload capacity if it was modified to use heavier springs and the speed it could maintain if its engine was retrofitted with a turbocharger to increase its horsepower or torque.

As another example, a server in a data center may be configured with a particular number of processors and a certain amount of memory to perform database queries. To continue the example, the server may be capable of adding additional processors and memory. In this example, the asset workload 348 service may be implemented to first determine how many database queries the server can perform with its current configuration of processors and memory. In this example, the asset workload 348 service may likewise to be implemented to determine how many database queries the server can perform if additional processors and memory, or a particular combination thereof, were to be added.

In certain embodiments, an asset performance 350 service may be implemented to provide information associated with the performance of one or more asset performance management operations. As used herein, as it relates to an asset for use in a complex asset environment, asset performance management broadly refers to a various activities involved in ensuring that certain goals are met in an effective and efficient manner by assessing, and managing, the performance of the asset when handling a particular workload. In certain embodiments, the asset performance management operation may be automatically performed by an asset performance management (APM) system, such as LiveOptics®, produced by Dell Technologies, Inc. of Round Rock, Tex.

In certain embodiments, an APM system may be implemented to improve the reliability and availability of physical assets while minimizing risk and operating costs. As typically implemented, an APM system may include condition monitoring, predictive maintenance, asset integrity management, and reliability-centered maintenance through the use of asset health data collection, visualization, and analytics. In certain embodiments, the implementation of an APM system may involve information sharing and application integration among operations and maintenance to provide a comprehensive view of production, asset performance, and product quality. In certain embodiments, the information provided by the asset performance 350 service may include data shared by various components and services of the sales facilitation system 118.

In certain embodiments, an APM system may be implemented to synchronize asset production and maintenance with information sharing and application integration among various customer systems. Examples of such systems include enterprise asset management, manufacturing execution, manufacturing operations management, plant asset management, asset integrity management. In certain embodiments, the systems and other solutions may be used to provide a comprehensive view of production and asset performance. Certain embodiments of the invention reflect an appreciation that the provision of certain APM information through the asset performance 350 service can increase cross-functional visibility, collaboration, and communication for better productivity, reliability, safety, quality, and return on assets.

In various embodiments, a digital marketing 352 service may be implemented to provide information associated with the performance of certain digital marketing operations. In various embodiments, the digital marketing operations may be performed by a digital marketing system 252, described in the text associated with FIG. 2. In various embodiments, a customer relationship management (CRM) 354 service may be implemented to provide information associated with the performance of certain CRM operations. In various embodiments, the CRM operations may be performed by a CRM system 254, likewise described in the text associated with FIG. 2.

In various embodiments, a customer mapping 356 service may be implemented to provide information associated with the performance of certain customer journey mapping operations. As used herein, customer journey mapping broadly refers to visualizing the story of the customer's experience with a selling organization by identifying key interactions and the customer's associated feelings, motivations, and questions at various touchpoints. Certain embodiments of the invention reflect an appreciation that mapping a customer's journey can assist a selling organization understand how a prospective or existing customer uses various sales channels and interact with associated touchpoints. Certain embodiments of the invention likewise reflect an appreciation that mapping a prospective or existing customer's journey can assist the sales organization understand how it is perceived, as well as achieving a better understanding of how its prospective and existing customers would like their experiences to be.

In various embodiments, a data analytics 358 service may be implemented to provide information associated with performing an analysis of a prospective or existing customer's history of utilizing certain assets in a complex asset environment. In various embodiments, performance of the analysis may result in the identification of certain asset utilization patterns. In certain embodiments, the asset utilization patterns may include information associated with asset types, asset quantities, asset use types, optimization types, asset workloads, asset performance, support information, and cost factors, or a combination thereof, as described in greater detail herein. In certain embodiments, the analysis may be performed by comparing information associated with a particular prospective or existing customer's asset utilization patterns to a repository of information associated with multiple prospective or existing customer's asset utilization patterns.

Certain embodiments of the invention reflect an appreciation that such a comparison may prove advantageous in facilitating the sale of an asset into a similar complex asset environment. As an example, a prospective or existing customer may be using a particular set of assets in their data center to deliver various web services in a cloud environment. In this example, the assets may include two server racks, each of which contain 42 blade servers, which in turn support 16 processor cores. To continue the example, the data center may be space-constrained and unable to support the addition of an additional server rack. To further continue the example, the prospective or existing customer may wish to increase the number of concurrent web services to support a growing user base while simultaneously lowering their power costs.

Accordingly, the data analytics 358 service may be used to compare asset utilization patterns associated with the current installed base of assets in the data center to similar asset utilization patterns stored in a repository of other asset utilization patterns. Once matching or similar asset utilization patterns are identified, associated asset solutions that have proven successful in the past may be identified. To continue the example, performance of various data analytics 358 services may indicate replacing half of the existing blade servers with higher performance blade servers supporting 32 processor cores. As a result, the prospective or existing customer could realize a 100% increase in throughput capacity while reducing power consumption by 40%, all while maintaining the existing server rack footprint in their data center.

In certain embodiments, a business intelligence (BI) 360 service may be implemented to provide information associated with the performance of certain BI operations familiar to skilled practitioners of the art. In certain embodiments, one or more BI operations may be provided by the BI 360 service to identify an optimum configuration of assets within a particular complex asset environment. As used herein, an optimum configuration of assets broadly refers to a configuration of assets that yield a particular advantage. In certain embodiments, the advantage may assist in attaining a particular objective. In certain embodiments, the objective may be set by the seller of an asset, the purchaser of the asset, or both. In these embodiments, the objective of the seller of the asset, the purchase of the asset, or both, is a matter of design choice.

As likewise used herein, as it relates to an optimum configuration of assets, an advantage broadly refers to the use of a particular asset in a complex asset environment to attain a certain goal. In certain embodiments, the advantage yielded by an optimum configuration of assets may be higher performance, lower operational cost, highest acceptable sales price, greater profit margin, reductions in TCO, quickest ROI, or a combination thereof, for a particular sales opportunity. As used herein, as it relates to an optimum configuration of assets, higher performance broadly refers to a configuration of assets yielding performance that is considered superior to the performance of an existing or proposed configuration of assets. As an example, a proposed server configured with four processors running at 2.4 GHz may provide higher performance than an existing server configured with four processors running at 1.8 GHz when processing the same workload. As likewise used herein, as it relates to an optimum configuration of assets, lower operational cost broadly refers to a configuration of assets providing a lower cost of operations than an existing or proposed configuration of assets. To continue the prior example, the server with four processors running at 2.4 GHz may likewise use 20% less power than the existing server configured with four processors running at 1.8 GHz when processing the same workload.

Likewise, as used herein, as it relates to an optimum configuration of assets, highest acceptable sales price broadly refers to the highest price an existing or prospective customer is willing to pay for a particular configuration of assets compared to another configuration of assets. As an example, a seller may propose a particular configuration of assets that is substantively similar to a competing configuration of assets. However, in this example, the seller's configuration of assets may be 15% higher than the competitors. Accordingly, the 15% higher cost of the seller's configuration of assets may not be acceptable to the prospective buyer.

As used herein, as it relates to an optimum configuration of assets, greater profit margin broadly refers to a particular configuration of assets that provides the seller a greater profit margin than another configuration of assets. As an example, a seller may have two configurations of assets that meet the objectives of a prospective buyer. In this example, either of the two configurations of assets is acceptable to the prospective buyer. However, one configuration may have a 27% profit margin while the second configuration may have a 32% profit margin. Accordingly, the configuration with the 32% profit margin would represent the optimum configuration of assets to the seller.

As likewise used herein, as it relates to an optimum configuration of assets, reductions in TCO broadly refers to a configuration of assets that provide a lower TCO than the TCO of an existing or proposed configuration of assets. To continue the previous example, the server with four processors running at 2.4 GHz, when combined with lower operational costs due to using 20% less power than the existing server configured with four processors running at 1.8 GHz, may provide a lower TCO when processing the same workload. Likewise, as used herein, as it relates to an optimum configuration of assets, quickest ROI broadly refers to a configuration of assets that provide a faster ROI than the ROI of an existing or proposed configuration of assets. To continue the previous example even further, the server with four processors running at 2.4 GHz, due to their greater performance and using 20% less power than the existing server configured with four processors running at 1.8 GHz, may provide a faster ROI when processing the same workload.

In certain embodiments, one or more BI operations may be provided by the BI 360 service to provide a variety of optimum configuration of assets, each of which may provide one advantage or another. As an example, one optimum configuration of assets may provide the lowest asset purchase cost, while another may provide the greatest savings in power costs, while yet another may provide the lowest TCO. In certain embodiments, the optimum configuration of assets may include two or more advantages.

Certain embodiments of the invention likewise reflect an appreciation that the advantages provided by an optimum configuration for one existing or prospective customer may not be considered advantageous by another. As an example, one customer may desire lowering their operational costs while simultaneously reducing their TCO, while another may desire the highest possible performance and that enables a target ROI metric. Likewise, the seller may desire the highest sales price acceptable to a buyer of an asset combined with the greatest possible profit margin. Accordingly, in certain embodiments, a sales facilitation operation may be implemented to determine an optimum configuration of assets that that provides the highest acceptable sales price combined with the greatest possible profit margin. Those of skill in the art will recognize that many such asset configurations are possible. Accordingly, the foregoing is not intended to limit the spirit, scope or intent of the invention.

In certain embodiments, a predictive analytics 362 service may be implemented to process the results of operations performed by other ancillary services 306 to provide predictions relevant to facilitating a sale of assets used in a complex asset environment. In certain embodiments, the predictions provided by the predictive analytics 362 service may be related to identifying factors most relevant to facilitating a sale. To further continue a previous example, the predictive analytics 362 service may provide a prediction that the benefits of replacing half of the prospective or current customer's blade servers with newer, more powerful and efficient blade servers is likely to result in closing a sale. In view of the foregoing, skilled practitioners of the art will recognize that many examples of ancillary services 306 are possible for use in performing a sales facilitation operation. Accordingly, the foregoing is not intended to limit the spirit, scope or intent of the invention.

In certain embodiments, the sales facilitation engine 120 may be implemented to include a total cost of ownership (TCO) and return on investment (ROI) module 364, an analytics/recommendations module 266, various administrator tools 368, and a graphical user interface (GUI) 370 controller, or a combination thereof. In certain embodiments, the sales facilitation engine 120 may likewise be implemented to include a usage history and reporting module 372, a proposal generation module 374, a prediction/insight generation module 376, and a machine learning engine 378, or a combination thereof.

In certain embodiments, the TCO/ROI module 364 may be implemented to perform TCO, ROI, IRR, and other financial calculations associated with a proposed sale of assets used in a complex asset environment. In certain embodiments, the results of the financial calculations performed by the TCO/ROI module 364 may be incorporated into sales facilitation content, described in greater detail herein. In certain embodiments, the results of the financial calculations performed by the TCO/ROI module 364 may be used as input to the proposal generation module 374, described in greater detail herein.

In certain embodiments, the analytics/recommendations module 266 may be implemented to analyze the results of financial calculations performed by the TCO/ROI module 364 and make sales facilitation recommendations. In certain embodiments, the recommendations generated by the analytics/recommendations module 266 may be used to provide guidance to sales personnel to improve the likelihood of making a sale of assets used in a complex asset environment. In certain embodiments, the recommendations generated by the analytics/recommendations module 266 may be used as input to the proposal generation module 374.

In various embodiments, certain system administrator tools 368, familiar to those of skill in the art, may be implemented to manage the sales facilitation system 118. In these embodiments, the system administrator tools 368 selected for managing the sales facilitation system 118, and the methods by which they may be used, is a matter of design choice. In certain embodiments, the GUI 370 controller may be implemented to generate graphical representations of certain outputs of the sales facilitation system 118. In certain embodiments, the GUI 370 controller may be used to provide such outputs as input to the proposal generation module 374.

In certain embodiments, the usage history and reporting module 372 may be implemented to track and report various metrics associated with the use of the sales facilitation system 118. In certain embodiments, the proposal generation module 374 may be implemented to generate various forms of sales collateral, including proposals for the sale of assets used in a complex asset environment. In certain embodiments, the prediction/insight generation module 376 may be implemented to predict the next stage of a sales cycle and provide insight into its probable outcome.

In certain embodiments, the machine learning engine 378 may be implemented to perform various machine learning operations, familiar to skilled practitioners of the art, to learn from various outcomes resulting from use of the sales facilitation system 118. In certain embodiments, the results of the machine learning operations may be used by the sales facilitation system 118 to facilitate future sales opportunities. In these embodiments, the method by which the machine learning operations may be implemented, and the method by which their results may be used by the sales facilitation system 118, is a matter of design choice. Those of skill in the art will recognize that many such embodiments of the use of the sales facilitation engine 120, or its individual components, is possible. Accordingly, the foregoing is not intended to limit the spirit, scope, or intent of the invention.

In certain embodiments, the output module 310 may be implemented to generate collateral 382, presentation 384, proposal 386, and electronic communications 388 components, or a combination thereof. In certain embodiments, a collateral 382 component may be in the form of sales collateral and related material commonly used in a sales process. In certain embodiments, a presentation 384 component may be in the form of a product or services overview, a market study or overview, a sales presentation, or some combination thereof. In certain embodiments, a proposal 386 component may be in the form of a response to a Request For Information (RFI) or Request For Proposal (RFP), an unsolicited proposal, or other proposal-related correspondence.

In certain embodiments, the electronic communications component 388 may be implemented to electronically communicate certain sales-related information to a prospective or existing customer, such as by an electronic mail (email) message or an electronic text message. In certain embodiments, the sales-related information communicated to a prospective or existing customer may include various collateral 382, presentation 384, and proposal 386 components. Skilled practitioners of the art will recognize that many such embodiments are possible. Accordingly, the foregoing is not intended to limit the spirit, scope, or intent of the invention.

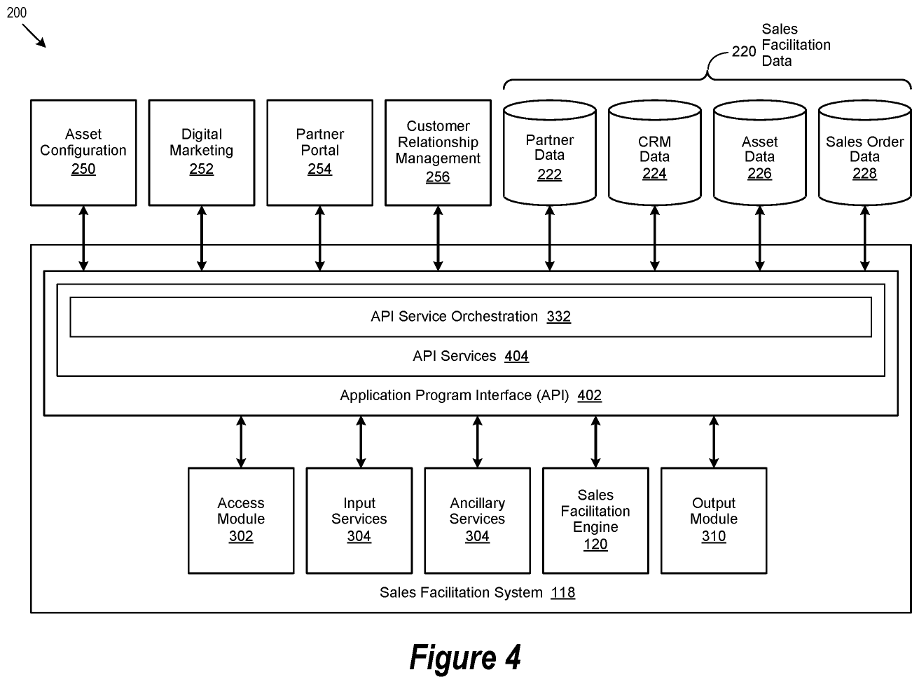

FIG. 4 shows the orchestration of elements of a sales facilitation environment implemented in accordance with an embodiment of the invention. In certain embodiments, a sales facilitation system 118, described in greater detail herein, may be implemented with an Application Program Interface (API) 402, familiar to skilled practitioners of the art. In certain embodiments, the API 402 of the sales facilitation system 118 may be implemented to enable various API services 404, which are in turn orchestrated, as likewise described in greater detail herein, by an API service orchestration 332 service.

In certain embodiments, the API 402 may be implemented to provide an interface to an access module 302, input services 304, ancillary services 302, a sales facilitation engine 120, and an output model 310, or a combination thereof, all of which are described in greater detail herein. In certain embodiments, the API 402 may be implemented to provide an interface between the sales facilitation system 118 and other systems. Examples of such systems include asset configuration 250, digital marketing 252, partner portal 254, and customer relationship management (CRM) 256 systems. In certain embodiments, the API 402 may be implemented to provide an interface to various repositories of sales facilitation data 220, likewise described in greater detail herein. Examples of such sales facilitation data 220 include partner 222, CRM 224, asset 226 and sales order 228 data.

In certain embodiments, various functionalities provided by the access module 302, input services 304, ancillary services 302, sales facilitation engine 120, and output model 310 may in turn be provided as an API service 404 to the sales facilitation system 118. In certain embodiments, various functionalities of the asset configuration 250, digital marketing 252, partner portal 254, and customer relationship management (CRM) 256 systems may be provided to the sales facilitation system 118 as one or more API services 404. In certain embodiments, access to data contained in the various repositories of sales facilitation data 220 make likewise be provided as one or more API services 404. Those of skill in the art will recognize that many such embodiments are possible. Accordingly, the foregoing is not intended to limit the spirit, scope, or intent of the invention.

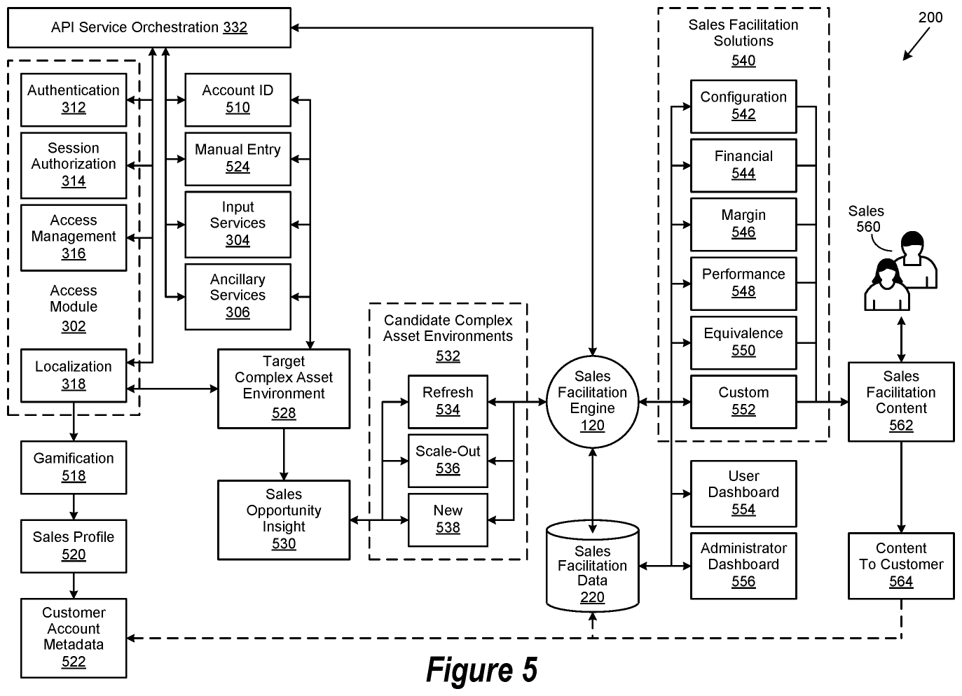

FIG. 5 shows a simplified process flow of the operation of a sales facilitation environment implemented in accordance with an embodiment of the invention. In certain embodiments, as described in greater detail herein, various sales facilitation operations may be performed in the sales facilitation environment 200 to facilitate a sale of an asset for use in a complex asset environment. In certain embodiments, as likewise described in greater detail herein, a sales facilitation engine 120 may be implemented to use information provided by an access module 302, input services 304, and ancillary services 306, or a combination thereof, to perform the sales facilitation operation. In certain embodiments, as described in greater detail herein, the access module 302, input services 304, ancillary services 306, and sales facilitation engine 120 may be implemented to exchange information via an Application Program Interface (API) orchestration 332 module.

In various embodiments, the API orchestration 332 module may likewise be implemented to exchange certain account identifier (ID) information provided by an account ID 510 module. As used herein, account ID information broadly refers to any information used to uniquely identify a prospective or existing customer. Examples of account ID information may include the name of a prospective or existing customer, associated address information, and contact information associated with certain employees or other personnel, such as names, phone numbers, email addresses, and so forth.

In various embodiments, the account ID 510 module may be implemented to automatically receive certain account ID information from an external system, such as a CRM system 256, described in greater detail herein. In various embodiments, the API orchestration 332 module may likewise be implemented to receive certain information manually provided to a manual entry 524 module. In various embodiments, the account ID 510 module may be implemented to receive certain manually-entered account ID information via the manual entry module 524. In these embodiments, the method by which the account ID information is selected, and the method by which it is obtained prior to its receipt by the account ID 510 module, is a matter of design choice. In certain embodiments, the resulting account ID information may be used in the performance of a sales facilitation operation, as described in greater detail herein.

In certain embodiments, the manual entry 524 module may be implemented to receive manual input of information associated with various assets used in a complex asset environment associated with a particular sales opportunity. In certain embodiments, the asset information may be provided by the current owner or operator of the assets. In various embodiments, the asset information may be provided by certain sales 560 personnel. In certain embodiments, the asset information may be inferred from other sources. In these embodiments, the method by which the asset information is inferred is a matter of design choice. In certain embodiments, asset information associated with one or more sales opportunities lost in the past may be entered into the manual entry 524 module. In certain embodiments, the resulting asset information may be used in the performance of a sales facilitation operation, as described in greater detail herein.

In certain embodiments, the performance of one or more sales facilitation operations may result in the generation of one or more target complex asset environments 528. As used herein a target complex asset environment 528 broadly refers to a collection of existing or proposed assets used in a complex asset environment. In certain embodiments, a target complex asset environment 528 may be associated with an existing or prospective customer.

In certain embodiments, the resulting one or more target complex asset environments 528 may likewise be used in the performance of one or more sales facilitation operations to generate one or more sales opportunity insights 530. As used herein, a sales opportunity insight 530 broadly refers to the identification of an opportunity to sell one or more assets for use in a complex sales environment. In certain embodiments, the resulting sales opportunity insights 530 may result in the generation of one or candidate complex asset environments 532. As used herein, a candidate complex asset environment 532 broadly refers to one or more candidate complex asset environments that would result from the successful sale of one or more assets.

In certain embodiments, a sales opportunity insight 530 may be implemented to describe the reasons for, or rationale leading to, the generation of a particular sales opportunity insight 530. As an example, a sales opportunity insight 530 may include the fact that half of a data center's servers are over five years old. In this example, the fact of the age of the servers, combined with the knowledge that current servers may cost less for the same or better performance, and have a lower TCO due to lower power consumption, provide the reasons and rationale for the sales opportunity insight 530. In certain embodiments, a localization service 318, described in greater detail herein, may be implemented to localize the sales opportunity insight 530.

In certain embodiments, the candidate complex asset environments 532 may include refreshed 534, scaled-out 536, new 538, or a combination thereof, candidate complex asset environments 532. As used herein, a refreshed 534 candidate complex asset environment 532 broadly refers to an existing complex asset environment where at least one asset is proposed to be replaced, upgraded, reconfigured, or added. As an example, certain servers in a data center may only support a small number of processors, which limits the number of virtual machines (VMs) they are able to run concurrently. In this example, a refreshed 534 candidate complex asset environment may include replacement of the older servers with newer servers capable of supporting a higher number of VMs running concurrently.

As likewise used herein, a scaled-out 536 candidate complex asset environment 532 broadly refers to an existing complex asset environment where the number of one or more assets is proposed to be increased. Using a variation of the previous example, a datacenter may have originally purchased more servers than needed for the workloads they supported at the time. However, over time, the original servers are now running at capacity. In this example, a scaled-out 536 candidate complex asset environment may entail proposing additional numbers of the original servers to allow additional workloads to be supported.

A new 538 candidate complex asset environment 532, as used herein, broadly refers to a proposed complex asset environment whose assets will be new. As an example, a new data center may be planned and needs to be equipped to support a variety of workloads, each of which has certain target performance goals. In this embodiment, information related to the various workflows, and their respective target performance goals, and the known capabilities of certain assets that could be proposed may be processed to generate a new 538 candidate complex asset environment.

In certain embodiments, the sales facilitation engine 120 may be implemented to process information respectively associated with various refreshed 534, scaled-out 536, or new 538 candidate complex asset environments 532 with relevant sales facilitation data 220 to generate one or more sales facilitation solutions 540. As used herein, a sales facilitation solution 540 broadly refers to a candidate complex asset environment 532 that meets certain sales objectives. In certain embodiments, the sales facilitation solutions 540 may include asset configuration 542, financial 544, profit margin 546, asset performance 548, and asset equivalence 550 solutions, or a combination thereof. In certain embodiments, a user 552 dashboard and an administrator 554 dashboard may be respectively implemented manage and administer the generation of various sales facilitation solutions 540.

As used herein, an asset configuration 542 solution broadly refers to a sales facilitation solution that addresses certain asset configuration objectives. In various embodiments, the asset configuration 542 solution may meet certain asset configuration objectives set by the seller of the asset, the prospective buyer of the asset, or a combination thereof. As an example, the operator of a data center may have a need to add 192 additional Ethernet switch ports, split equally between four equipment racks, to service anticipated growth in their user base.

In this example, the manufacturer may produce two configurations of Ethernet switches. One with 48 ports and the other with 24 ports. To continue the example, one asset configuration 542 solution may be to propose a single 48 port switch for each equipment rack, while a second asset configuration 542 solution may be to propose two 24 port switches for each equipment rack. In this example, either asset configuration 542 solution meets the asset configuration objectives of the prospective buyer.

As used herein, a financial 544 solution broadly refers to a sales facilitation solution 540 that addresses certain financial objectives. In various embodiments, the financial 544 solution may meet certain financial objectives set by the seller of the asset, the prospective buyer of the asset, or a combination thereof. To continue the previous example, the manufacturer of Ethernet switches may follow a sales philosophy of achieving maximum financial value from a customer, even if that achievement is over time. Likewise, the operator of the data center may wish to limit how much they expend on infrastructure expansion at any particular point in time. Furthermore, while the cost of a 48 port switch is only 50% higher than a 24 port switch, the data center owner may not need to add all 192 Ethernet ports at one time.

Accordingly, a financial 544 solution may entail the manufacturer proposing the sale of eight 24 port switches, in two groups of four, as growth in the data center's user base justifies the expenditure. As a result, the financial objectives of the manufacturer and the data center operator are met. The manufacturer maximizes the financial value of their customer as more revenue will be realized in total due to the higher sales price of eight 24 port switches compared to the cost of four 48 port switches. Likewise, the data center operator can align the cost of expanding their infrastructure to the growth of their user base.

As used herein, a profit margin 546 solution broadly refers to a sales facilitation solution 546 that addresses certain profit margin objectives for the seller of an asset. To further continue the previous example, the Ethernet switch manufacturer may have an overstock of 48 port switches, which have a higher per-port profit margin than 24 port switches. Accordingly, one profit margin 546 solution may entail proposing the data center operator making a one-time expenditure to purchase four 48 port switches instead of eight 24 port switches in two groups of four. In this example, the benefit of the profit margin 546 solution to the manufacturer is they realize a higher profit margin, albeit at reduced total revenue. Likewise, the benefit to the data center owner is a lower price per port, albeit at the expense of making a single purchase at a higher cost instead of two purchases at a lower cost.

As used herein, an asset performance 548 solution broadly refers to a sales facilitation solution that addresses certain asset performance objectives. In various embodiments, the asset performance 548 solution may meet certain asset performance objectives set by the prospective buyer of the asset. To continue the previous example yet further, the installed base of Ethernet switches in the data center may be older and only support speeds of 100 Mbs, which limits server performance when transferring large files used for certain workloads. Accordingly, one asset performance 548 solution may entail proposing existing 100 Mbs switches being replaced with gigabit switches. In this example, the asset performance 548 solution provides the data center owner three benefits. First, large files can be transferred faster. Second, server utilization is improved. Third, improved utilization of servers will likely result in additional resources that can be used to support additional workloads.

As used herein, an asset performance equivalence 550 solution broadly refers to a sales facilitation solution that addresses various objectives related to replacing certain asset with other assets capable of providing equivalent performance. In various embodiments, the asset performance equivalence 550 solution may meet certain asset performance equivalence objectives set by the seller of the asset, the prospective buyer of the asset, or a combination thereof. To continue the preceding example yet still further, the data center operator may currently own eight 24 port gigabit Ethernet switches, which occupy two slots in each of four racks, all of which are at capacity with no further expansion possible. Furthermore, the data center owner would like to add four additional blade servers without purchasing a fifth rack.

Accordingly, one possible asset performance equivalence 550 solution may entail the manufacturer proposing the replacement of the eight 24 port switches with four 48 port switches, which would result in sufficient space in each rack to add an additional blade server. In certain embodiments, two or more individual sales facilitation solutions 540 may be combined, in whole or in part, to generate a custom sales facilitation solution 540. As an example, certain aspects of a financial 544 sales facilitation solution may be combined with certain aspects of performance 542 sales facilitation solution to generate a custom 552 sales facilitation solutions that provides a trade-off between cost and performance. Skilled practitioners of the art will recognize many such embodiments of sales facilitation solutions 540, and associated examples or their implementation, are possible. Accordingly, the foregoing is not intended to limit the spirit, scope, or intent of the invention.

Examples of sales facilitation content 562 include various forms of sales collateral, product and service presentations, sales proposals, and other content used to convey asset information to prospective and existing customers. In certain embodiments, the sales facilitation 562 content may be implemented to include sales facilitation guidance to sales 560 personnel at various stages of a sales process. As an example, the sales facilitation 562 content may include certain prospect qualification questions that should be answered before proceeding to the next phase of the sales process. As another example, the sales facilitation 562 content may include suggestions regarding which sales facilitation content to provide 564 to an existing or prospective customer at what stage of the sales process and to whom. As yet another example the sales facilitation 562 content may include a proposal for an asset used in a complex asset and suggestions on how to use it. Those of skill in the art will recognize many such examples of sales facilitation 562 content, and how it may be used to facilitate a sale, are possible. Accordingly, the foregoing is not intended to limit the spirit, scope or intent of the invention.

In various embodiments, a user dashboard 554 may be implemented to provide certain sales personnel the ability to manage which sales facilitation content 562 is provided 564 to an existing or prospective customer 564. In various embodiments, an administrator dashboard 556 may be implemented to allow an administrator, or sales management, to receive summary and detail information related to which sales facilitation content 562 was used, at what point in time, by certain sales 560 personnel. In various embodiments, summary and detail information related to which sales facilitation content 562 was used, at what point in time, by certain sales 560 personnel may be stored in the repository of sales facilitation data 220, described in greater detail herein.

In certain embodiments, the use of certain sales facilitation 562 content by various sales 560 personnel, or its provision 564 to an existing or prospective customer, or both, may cause one or more sales facilitation results 566. As an example, an existing or prospective customer may request additional information, sales collateral, or sales presentations related to a particular asset used in a complex asset environment. As another example, a sale may be closed. Conversely, the sale may be lost. Alternatively, the existing or prospective customer may ask for a proposal for a different asset.

In various embodiments, certain metadata related to which sales facilitation content 562 was used, at what point in time, by certain sales 560 personnel, for which existing or prospective customer, and its associated sales facilitation results 566 may be stored in the repository of sales facilitation data 220. In certain embodiments, the sales facilitation engine 120 may be implemented to use a machine learning engine, described in greater detail herein, to use such information to facilitate future sales of assets used in complex asset environments. As an example, a sale of certain assets to an existing or prospective customer with a particular complex asset environment may have been successful. Accordingly, information related to which sales facilitation content 562 was used may be provided to facilitate sales of the same type of assets to existing or prospective customers who have a substantively similar complex asset environment. Conversely, a sale of certain assets to an existing or prospective customer with a particular complex asset environment may have been unsuccessful. Accordingly, information may be provided to 560 sales personnel to assist in determining which sales facilitation content 562 may be more helpful in closing sales of the same type of assets to existing or prospective customers who have a substantively similar complex asset environment.

In various embodiments, certain metadata associated with summary and detail information related to which sales facilitation content 562 was used, at what point in time, by certain sales 560 personnel may likewise be associated with customer account metadata 522. In these embodiments, the metadata selected to associate with the customer account metadata 522, and the method by which it is associated, is a matter of design choice. Various embodiments of the invention reflect an appreciation that the ability to tell what sales facilitation content 562 was used, at what point in time, by certain sales 560 personnel, and its associated metadata, may provide auditable sales activity information.

In certain embodiments, a gamification module 518 may be implemented to assist in incenting sales 560 personnel in their sales efforts. As used herein, gamification broadly refers to the application of game principles and design elements in a non-game context, such as a sales process. As an example, various gamification approaches may be implemented to incent various sales 560 personnel to excel in their respective sales efforts. To continue the example, various numbers of points may be assigned to successfully closing sales for a particular asset, with a prize or other compensation being awarded to the sales 560 person with the highest number of accumulated points by the end of a financial reporting period.

In various embodiments the gamification module 518 may be implemented to facilitate sales of certain assets by dynamically incenting certain sales 560 personnel to promote one or more sales facilitation solutions 540 to a particular prospective or existing customer. As an example, a manufacturer of storage arrays may produce various arrays that have a higher profit margin than others. Furthermore, certain of these arrays may offer a high level of performance for their price. In this example, one or more sales opportunity insights 630 may be generated to identify optimum candidate complex asset environments 532 associated with a prospective or existing customer. In turn, various sales facilitation solutions 540, described in greater detail herein, may in turn be presented to certain sales 560 personnel assigned to those opportunities. Concurrently, the gamification module 518 may be implemented to increase sales incentives for those opportunities to encourage the sales 560 personnel to close a sale.

In certain embodiments, a localization service 318 may be implemented to localize such gamification approaches. In certain embodiments, the results of various gamification approaches are added to a sales profile 520. In certain embodiments, the sales profile may be implemented to track the various sales activities, and results for a sales entity. In certain embodiments, the sales entity may be an individual salesperson, a group of sales personnel, a sales manager associated with such a group, a sales region or territory, a reseller, a distributor, a channel partner, or other affiliated sales entity.

In certain embodiments, the sales activities and results associated with a particular sales entity may in turn be associated with customer account metadata 522 associated with an assigned prospective or existing customer. Those of skill in the art will recognize that many such embodiments are possible. Accordingly, the foregoing is not intended to limit the spirit, scope or intent of the invention.

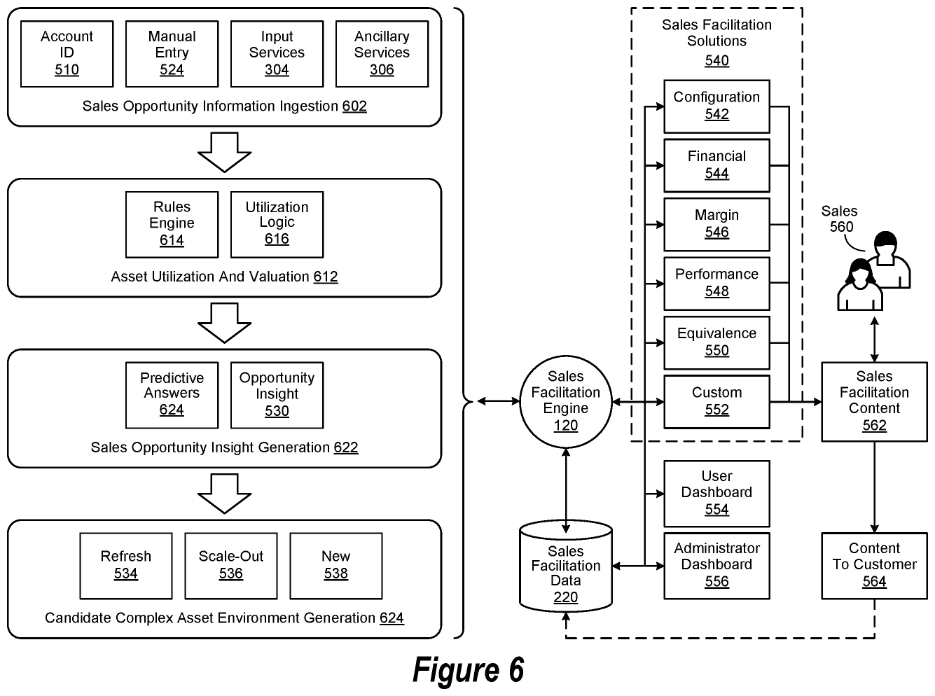

FIG. 6 shows a simplified process flow of operations performed in accordance with an embodiment of the invention to generate a candidate complex asset environment. In certain embodiments, information related to a complex asset environment associated with a prospective or existing customer is collected during a sales opportunity information ingestion 602 phase. As described in greater detail herein, the complex asset environment may or may not currently exist. For example, a prospective customer may be operating four data centers, but is planning on establishing a fifth. In this example, significant information about the first four data centers may exist, but only planning data is available for the fifth. As likewise described in greater detail herein, the information may be provided by an account identifier (ID) module 510, a manual entry module 524, input services 304, and ancillary services 306.

The collected information is then processed in an asset utilization and valuation 612 phase to arrive at a preliminary determination whether or not it may represent a sales opportunity. In certain embodiments, a rules engine 614 familiar to those of skill in the art may be implemented in combination with certain utilization logic 616 to make the determination. In various embodiments, the utilization logic 616 may be associated with the utilization of certain assets used in a complex asset environment, as described in greater detail herein. In certain embodiments, the utilization logic 616 may be dynamically provided to the rules engine 614 according to the information collected during the sales opportunity information ingestion 602 phase.

As an example, one set of utilization logic 616 may be provided to the rules engine 614 if the collected information is related to a fleet of delivery trucks and associated maintenance equipment. Likewise, a different set of utilization logic 616 may be provided if the collected information is related to servers and storage arrays in a data center. As another example, a first set of utilization logic 616 may be provided for a data center located in one country, while a second set of utilization logic 616 may be provided for a data center located in another. In these embodiments, the method by which the rules engine 614 and the utilization logic 616 may be implemented is a matter of design choice.

If a preliminary determination is made during the asset utilization and valuation phase 612 that the information collected during the sales opportunity information ingestion 602 phase represents a sales opportunity, then a sales opportunity insight 530, described in greater detail herein, is generated during a sales opportunity insight generation 622 phase. In certain embodiments various predictive answers 624 may be used to generate the sales opportunity insight 530. In certain embodiments, the predictive answers 624 may be generated by a predictive analytics service 362, describe in the descriptive text associated with FIG. 3. In certain embodiments, a machine learning engine 378, likewise described in the descriptive text associated with FIG. 3, may be implemented to use the predictive answers to generate the sales opportunity insight 530.

In certain embodiments, the resulting sales opportunity insight 530 is then processed in a candidate complex asset environment 624 phase to generate a refreshed 534, scaled-out 536, or new 538 candidate complex asset environment, described in greater detail herein. In certain embodiments, processing of the sales opportunity insight 530 may result in one or more refreshed 534, scaled-out 536, or new 538 candidate complex asset environments being generated. The resulting refreshed 534, scaled-out 536, or new 538 candidate complex asset environments are then processed by a sales facilitation engine, as described in greater detail herein, to generate one or more sales facilitation solutions 540, likewise described in greater detail herein.

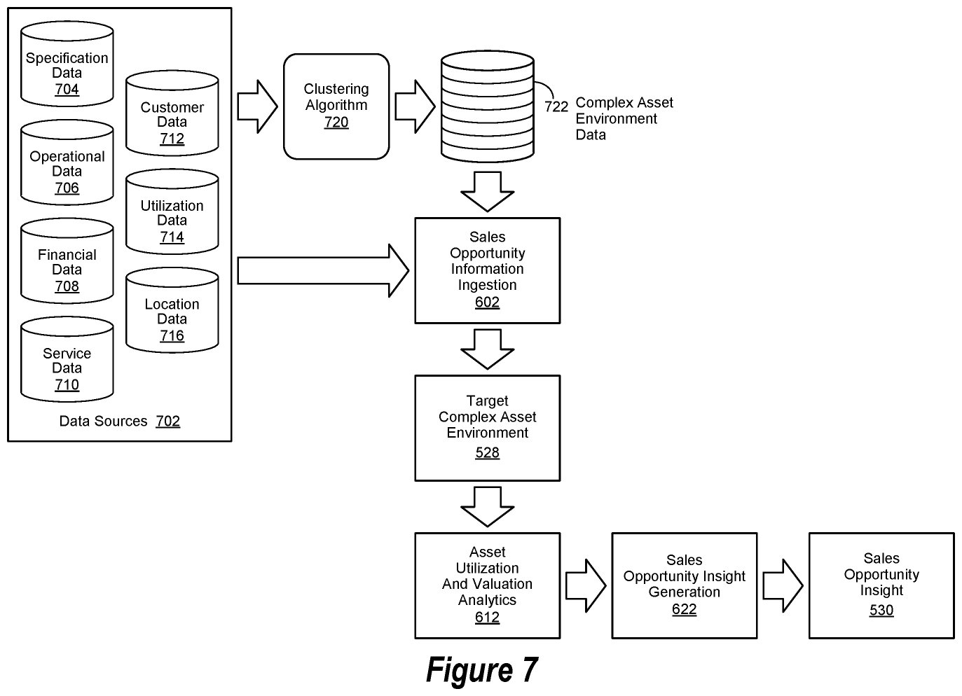

FIG. 7 shows a simplified process flow for generating a sales opportunity insight implemented in accordance with an embodiment of the invention. In certain embodiments, data sourced from various data sources 702 may be processed with a clustering algorithm 720 to generate complex asset environment data 722. In certain embodiments, data sourced from the data sources 702 may include asset specification 704 data from an asset specification data source, asset operational 706 data from an asset operational data source, asset financial 708 data from an asset financial data source, asset service 710 data from an asset service data source, asset utilization 714 data from an asset utilization data source, and asset location 716 data from an asset location data source, or a combination thereof. In certain embodiments, data sourced from the data sources 702 may likewise include various types of customer 712 data associated with one or more prospective or existing customers, described in greater detail herein. In these embodiments, the source of the data sources 702, and the method by which it is identified, collected, and aggregated, is a matter of design choice.

As used herein, asset specification 704 data broadly refers to various types of data that may be used to describe one or more aspects of a particular asset. Examples of asset specification 704 data may include serial numbers or other unique identifiers, model names and numbers, configuration information, functional component identifiers, such as Media Access Control (MAC) and International Mobile Equipment Identity (IMEI) numbers. Other examples of asset specification data may include features, capabilities, and performance specifications, as well as capacity, color, size, weight, and shape descriptors, and revision numbers or dates.

In certain embodiments, the asset specification 704 data may be implemented to uniquely describe a particular asset. As an example, an asset's serial number may be implemented to uniquely identify a particular server. However, while a serial number may uniquely identify a particular asset, it may not provide information that describes the asset's distinguishing features, configuration, functionalities, or capabilities. To continue the example, a data center may have fifty identically-configured servers, all of which have the same model name and performance characteristics, yet they have different serial numbers. Accordingly, various embodiments of the invention reflect an appreciation that certain asset specification 704 data may prove useful in identifying a group of identical, or substantively similar, assets while simultaneously being able to uniquely identify each one.

As used herein, asset operational 706 data broadly refers to various types of data that may be used to describe various aspects of the operation of a particular asset. Examples of asset operational 706 data may include the amount of heat or noise the asset produces when operating under certain conditions and the amount of energy or fuel it may consume. Other examples of asset operational 706 data may include various environmental considerations, parameters, or requirements and associated characteristics of a user of the asset, such as knowledge, skill level, or required certifications.

In certain embodiments, the asset operational 706 data may be implemented to describe the operation of a particular asset for a particular use. As an example, a road grader may produce a certain noise level and consume a certain amount of fuel when operating under maximum power. In this example, the noise level the road grader produces under maximum power may violate local noise ordinances and use more fuel than is necessary for accomplishing a particular task. To continue the example, certain certifications or skill levels may be recommended for the operator of the road grader, as they may be able to accomplish the same task without the use of maximum power to do so. Accordingly, various embodiments of the invention reflect an appreciation that certain asset operational 706 data may prove useful in identifying a group of assets sharing identical, or substantively similar, operational characteristics when performing a particular function.

As used herein, asset financial 708 data broadly refers to various types of data that may be implemented to describe financial aspects of a particular asset. In various embodiments the asset financial 708 data may include various types of data that may be used to determine the cost or value of a particular asset. Examples of asset financial 708 data may include the list price of an asset on a particular date in certain markets, the actual or inferred cost of the same asset on the same date within the same markets, and its actual or inferred current value within those markets. Examples of other financial 708 data may include data associated with the cost to operate the asset, such as energy or fuel costs, and costs for maintaining and servicing the asset. Other examples of financial 708 data may include costs associated with the use of floor, ground, or storage space, employment costs of operators or users, and so forth. Yet other examples of asset financial 708 data may include Total Cost of Ownership (TCO), Return on Investment (ROI), Internal Rate of Return (IRR), interest rates, depreciation intervals and associated rates, various market indexes, and other financial factors.

In certain embodiments, the asset financial 708 data may be implemented to determine the optimal time to replace a particular asset with a new asset. As an example, a data center may have purchased a group of servers several years ago. In this example, certain asset financial 708 data may be known, such as their original purchase cost, their yearly cost to operate, and an inferred current market value. To continue the example, the server's current market value is now equal to their depreciated value. Furthermore, new servers that consume less power and rack space while providing similar performance with longer maintenance intervals are available at attractive prices. Accordingly, the foregoing asset financial 708 may be used in certain embodiments to perform various TCO, ROI, and IRR calculations to see whether replacing an existing asset with a new asset makes financial sense.

As used herein, asset service 710 data broadly refers to various types of data that may be used to describe the provision of certain services to maintain a particular asset. As described in greater detail herein, servicing of an asset may be provided under an associated warranty or service contract. In certain embodiments, the service may be performed in the absence of such an associated warranty or service contract. In various embodiments, certain asset service 710 data may be used to ascertain whether a particular asset is covered under an associated warranty or service contract, and if so, when such coverage may expire.

In various embodiments, certain asset service 710 data may be used to determine the likelihood of a particular asset requiring unexpected maintenance or other servicing when not covered under an associated warranty or service contract. In various embodiments, certain asset service 710 data may be used to determine the cost of servicing a particular asset that is not covered under an associated warranty or service contract. Accordingly, the foregoing asset service 710 data may be used in certain embodiments to not only determine which assets are not currently covered an associated warranty or service contract, but to also anticipate when unexpected maintenance or servicing might be required, and at what cost.

As used herein, customer 712 data broadly refers to any data associated with an existing or prospective customer that may currently use, or is interested in using, a particular asset in a complex asset environment, as described in greater detail herein. In certain embodiments, the customer 712 data may be associated with an organization, such as a corporation or government agency, a group, such as a workgroup of users, or an individual user.

As used herein, asset utilization 714 data broadly refers to various types of data related to the use of various assets in a complex asset environment, as likewise described in greater detail herein. In certain embodiments, the customer 712 and asset utilization 714 data may be used in combination to identify existing or prospective customers who have similar asset utilization patterns of their respective assets. Certain embodiments of the invention reflect an appreciation that using such customer 712 and asset utilization 714 data may facilitate the sale of an asset used in a complex asset environment.

As used herein, asset location 716 data broadly refers to various types of data that may be used to identify the location of a particular asset. Examples of asset location 716 data may include street addresses, floor and room numbers, state, county, and city names, ZIP and telephone area codes. Other examples of asset location 716 data may include latitude, longitude and elevation references, various Geographic Information System (GIS) and Geographic Positioning System (GPS) information, and certain temporal information, such as timestamps.

In certain embodiments, the asset location 716 data may be used to locate various assets used in a complex asset environment. As an example, certain asset location 716 data may be used to identify a certain class, or model, of server within one or more data centers. In this example, five similarly-configured servers may be scattered across different physical locations in a data center. To continue the example, while all five servers may share a similar configuration, none of them are optimized for the tasks they are currently performing. To continue the example further, the use of certain asset location 716 data may assist in determining where the servers are located and replacing them with a single, larger server that can be more easily optimized to improve performance of the same tasks.

As another example, a highway construction company may own five bulldozers, each of which has certain unique capabilities, and two trailers, each of which can only carry one bulldozer at a time. In this example, certain asset location 716 data may be used to determine the location of each of the five bulldozers and the two trailers at any particular point in time. To continue the example, the asset location 716 data respectively associated with each of the bulldozers and trailers can be used to determine which bulldozer is carried by which trailer, at what time, to what location, that may require a unique capability of one bulldozer or another. Those of skill in the art will recognize many such examples of data sourced from various data sources 702 are possible. Accordingly, the foregoing is not intended to limit the spirit, scope or intent of the invention.

In various embodiments, a clustering algorithm 720 may be implemented to process data sourced from certain data sources 702 to generate a collection of complex asset environment 722 data. Skilled practitioners of the art will be familiar with clustering algorithms, including k-means clustering, which are used in various machine learning approaches to group similar objects. In certain embodiments, such objects may represent an asset used in a complex asset environment. In certain embodiments, such objects may represent one or more attributes associated with a particular asset used in a complex asset environment. In certain embodiments, the objects grouped into one group may be more similar to one another than they are to objects grouped into other groups.

In certain embodiments, the group of objects resulting from the implementation of the clustering algorithm 720 may be represented by the collection of complex asset environment 722 data. In certain embodiments, the clustering algorithm may be implemented to generate two or more collections of complex asset environment 722 data that are substantively similar. As an example, two collections of complex asset environment 722 data may be respectively associated with two different data centers. In this example, the two data centers may be owned by the same owner. To continue the example, comparing the two collections of complex asset environment 722 data may assist the owner in mirroring the two data centers.

As another example, the two data centers may be owned by different owners. In this embodiment one data center may be owned by an existing customer, while the other is owned by a prospective customer. To continue the example, the collection of complex asset environment 722 data associated with the data center owned by the existing customer may be used to facilitate the sale of a particular asset for use in the data center owned by the prospective customer. To further continue the example, while the servers used in both data centers may have similar configurations used to process a particular type of workload, asset utilization realized by the existing customer may be higher than that realized by the prospective customer. Accordingly, a sale to the prospective customer may be facilitated by showing how higher utilization may be realized by duplicating the configuration of certain servers used by the existing customer.

In certain embodiments, the clustering algorithm may be implemented to generate two or more collections of complex asset environment 722 data that are substantively different. As an example, a first collection of complex asset environment 722 data may be associated with an existing customer who owns a data center, while a second collection may be associated with an existing customer who owns an Internet Service Provider (ISP). Those of skill in the art will appreciate that while certain assets used in the complex asset environment operated by the data center and the ISP may be substantively the same, their intended use, or respective workloads, may be significantly different. Accordingly, subsets of the two collections of complex asset environment 722 data that are substantively similar may be used in certain embodiments to facilitate a sale to one customer or another.

In certain embodiments one or more collections of complex asset environment 722 data may be ingested during a sales opportunity information ingestion 602 phase, described in greater detail herein. In various embodiments, the sales opportunity information ingestion 602 phase may be implemented to use data sourced from certain data sources 702 in combination with the one or more collections of complex asset environment 722 data. As an example, certain financial data associated with various assets may not be present in the one or more collections of complex asset environment 722 data, but is available as data sourced from certain data sources 702.

In certain embodiments, the sales opportunity information ingestion 602 phase may be implemented to generate a target complex asset environment 528, described in greater detail herein. In certain embodiments, the resulting target complex asset environment 528 may in turn be processed during an asset utilization and analytics 612 phase, described in greater detail herein. In turn, the results of the asset utilization and analytics 612 phase may be processed during a sales opportunity insight generation 622 phase to generate a sales opportunity insight 530, both of which are described in greater detail herein.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a sales facilitation operation, comprising:
identifying a plurality of assets within a complex asset environment;
collecting information regarding the plurality of assets within the complex asset environment, the information regarding each of the plurality of assets comprising information from a plurality of data sources;
ingesting the information regarding the plurality of assets within the complex asset environment into a sales facilitation system; and,
performing the sales facilitation operation using the information regarding each of the plurality of assets within the complex asset environment.

2. The method of claim 1, further comprising:
generating a target complex asset environment using the information regarding each of the plurality of assets within the complex asset environment; and wherein
the target complex asset environment data is used when performing the sales facilitation operation.

3. The method of claim 1, wherein:
the plurality of data sources comprise an asset specification data source, the asset specification data source providing asset specification data, the asset specification data describing an aspect of a particular asset.

4. The method of claim 1, wherein:
the plurality of data sources comprise an asset operational data source, the asset operational data source providing asset operational data, the asset operational data describing an operational aspect of a particular asset.

5. The method of claim 1, wherein:
the plurality of data sources comprise an asset financial data source, the asset financial data source providing asset financial data, the asset financial data describing a financial aspect of a particular asset.

6. The method of claim 1, wherein:
the plurality of data sources comprise an asset service data source, the asset service data source providing asset service data, the asset service data describing information relating to provision of a service to maintain a particular asset.

7. The method of claim 1, wherein:
the plurality of data sources comprise a customer data source, the customer service data source providing customer data, the customer data describing information associated with a customer.

8. The method of claim 1, wherein:
the plurality of data sources comprise an asset location data source, the asset location data source providing asset location data, the asset location data comprising information associated with a location of a particular asset.

9. The method of claim 1, wherein:
the plurality of data sources comprise a utilization data source, the utilization data source providing utilization data, the utilization data comprising information related to use of an asset within a complex asset environment.

10. The method of claim 1, wherein:
the plurality of data sources comprise an asset location data source, the asset location data source providing asset location data, the asset location data comprising information associated with a location of a particular asset.

11. A system comprising:
a processor;
a data bus coupled to the processor; and
a non-transitory, computer-readable storage medium embodying computer program code for performing a sales facilitation operation, the non-transitory, computer-readable storage medium being coupled to the data bus, the computer program code interacting with a plurality of computer operations and comprising instructions executable by the processor and configured for:
identifying a plurality of assets within a complex asset environment;
collecting information regarding the plurality of assets within the complex asset environment, the information regarding each of the plurality of assets comprising information from a plurality of data sources; and,
performing the sales facilitation operation using the information regarding each of the plurality of assets within the complex asset environment.

12. The system of claim 11, wherein the instructions executable by the processor are further configured for:
performing a clustering operation on the information regarding each of the plurality of assets within the complex asset environment.

13. The system of claim 11, wherein:
the plurality of data sources comprise an asset specification data source, the asset specification data source providing asset specification data, the asset specification data describing an aspect of a particular asset.

14. The system of claim 11, wherein:
the plurality of data sources comprise an asset operational data source, the asset operational data source providing asset operational data, the asset operational data describing an operational aspect of a particular asset.

15. The system of claim 11, wherein:
the plurality of data sources comprise an asset financial data source, the asset financial data source providing asset financial data, the asset financial data describing a financial aspect of a particular asset.

16. The system of claim 11, wherein:
the plurality of data sources comprise an asset service data source, the asset service data source providing asset service data, the asset service data describing information relating to provision of a service to maintain a particular asset.

17. The system of claim 11, wherein:
the plurality of data sources comprise a customer data source, the customer service data source providing customer data, the customer data describing information associated with a customer.

18. The system of claim 11, wherein:
the plurality of data sources comprise an asset location data source, the asset location data source providing asset location data, the asset location data comprising information associated with a location of a particular asset.

19. The system of claim 11, wherein:
the plurality of data sources comprise a utilization data source, the utilization data source providing utilization data, the utilization data comprising information related to use of an asset within a complex asset environment.

20. The system of claim 11, wherein:
the plurality of data sources comprise an asset location data source, the asset location data source providing asset location data, the asset location data comprising information associated with a location of a particular asset.
